(19) United States
(12) Patent Application Publication
(10) Pub. No.: US 2023/0265266 A1
(43) Pub. Date: Aug. 24, 2023

(54) NATURAL RUBBER WITH HIGH STRENGTH AND HIGH ELONGATION AND HIGH RESILIENCE

(71) Applicant: Xiamen Hexin Technology Co., Ltd., Kiamen (CN)

(72) Inventors: Zhennan XU, Xiamen (CN); Zhongxin DUAN, Xiamen (CN)

(21) Appl. No.: 17/716,364

(22) Filed: Apr. 8, 2022

(30) Foreign Application Priority Data
Feb. 21, 2022 (CN) 202210155848.6

(51) Int. Cl. C08L 7/00

(52) U.S. Cl. CPC C08L 7/00

(57) ABSTRACT

The invention relates to a natural rubber with high strength, high elongation and high resilience, comprising the following raw materials in mass part: 0˜100 phr of RSS3, 0˜100 phr of 3 L rubber, 0˜100 phr of CV60 constant viscosity rubber, 2˜20 phr of zinc oxide, 0.1˜3 phr of stearic acid, 0.2˜2 phr of polyethylene glycol, 1˜20 phr of nano calcium carbonate, 2˜15 phr of nano kaolin, 2˜20 phr of naphthenic oil, 0.1˜2 phr of sulfur, 0.5˜3 phr of rubber accelerator. The invention has the following advantages: it has the characteristics of high strength, high elongation and high resilience, and is suitable for industrialized mass production, the required color and thickness can be made according to the needs, it is latex-free, ammonia-free, hypoallergenic and irritating to the skin, is suitable for making various rubber products with high requirements on strength, elongation, resilience and color.

### TECHNICAL FIELD

The invention relates to a natural rubber with high strength, high elongation and high resilience.

### BACKGROUND

Rubber refers to a highly elastic polymer material with reversible deformation, which is elastic at room temperature, can produce large deformation under the action of a small external force, and can return to its original shape after removing the external force. Rubber is a completely amorphous polymer, its glass transition temperature (T g) is low, and its molecular weight is often large, greater than several hundred thousand. Rubber is divided into natural rubber and synthetic rubber. Natural rubber is made by processing the colloid, which is extracted from rubber trees, rubber grass and other plants; synthetic rubber is obtained by polymerization of various monomers. Rubber products are widely used in all aspects of industry or life.

Natural rubber is divided into two forms: latex and dry rubber, the strength, resilience, elongation and other physical properties of latex are better, but the finished product is more expensive and easy to cause skin allergies. The cost of dry rubber is lower, it is not easy to cause allergic, but the physical properties are generally not as good as latex, developing the formulation of a dry rubber material with high strength, high elongation and high resilience has become a research direction.

### SUMMARY OF THE INVENTION

The object of the invention is to provide a natural rubber with high strength, high elongation and high resilience to solve the problems raised in the background.

To solve the above technical problems, the invention provides the following technical scheme: a natural rubber with high strength, high elongation and high resilience, comprising the following raw materials in mass part: 0˜100 phr of RSS3, 0˜100 phr of 3 L rubber, 0˜100 phr of CV60 constant viscosity rubber, 2˜20 phr of zinc oxide, 0.1˜3 phr of stearic acid, 0.2˜2 phr of polyethylene glycol, 1˜20 phr of nano calcium carbonate, 2˜15 phr of nano kaolin, 2˜20 phr of naphthenic oil, 0.1˜2 phr of sulfur, 0.5˜3 phr of rubber accelerator.

Preferably, a natural rubber with high strength, high elongation and high resilience, it is made by the following steps:

1) adding RSS3, 3 L rubber, CV60 constant viscosity rubber, zinc oxide, stearic acid, polyethylene glycol, nano calcium carbonate, nano kaolin, naphthenic oil, sulfur, rubber accelerator into the rubber internal mixer in order;

2) mixing at a speed of 5˜50 r/min and a cooling water flux of 1˜50 m³/h, and discharging after reaching the time of 30˜120 min and temperature of 100˜200° C.;

3) extruding sheets on open mixer or double cone/double wrist sheeting extruder;

4) cooling;

5) re-adding vulcanizing agent to the internal mixer or open mixer and produce sheets;

6) obtaining the finished product after cooling.

The invention has the following advantages: it has the characteristics of high strength, high elongation and high resilience, and is suitable for industrialized mass production, the required color and thickness can be made according to the needs, it is latex-free, ammonia-free, hypoallergenic and irritating to the skin, is suitable for making various rubber products with high requirements on strength, elongation, resilience and color.

### DESCRIPTION OF EMBODIMENTS

The invention will be described below with specific embodiments, but not intended to limit the invention.

### Embodiment 1

A natural rubber with high strength, high elongation and high resilience, comprising the following raw materials in mass part: 0 phr of RSS3, 100 phr of 3 L rubber, 0 phr of CV60 constant viscosity rubber, 20 phr of zinc oxide, 0.1 phr of stearic acid, 2 phr of polyethylene glycol, 1 phr of nano calcium carbonate, 15 phr of nano kaolin, 2 phr of naphthenic oil, 2 phr of sulfur, 0.5 phr of rubber accelerator.

Preferably, a natural rubber with high strength, high elongation and high resilience, it is made by the following steps:

1) adding RSS3, 3 L rubber, CV60 constant viscosity rubber, zinc oxide, stearic acid, polyethylene glycol, nano calcium carbonate, nano kaolin, naphthenic oil, sulfur, rubber accelerator into the rubber internal mixer in order;

2) mixing at a speed of 5˜50 r/min and a cooling water flux of 1˜50 m³/h, and discharging after reaching the time of 30˜120 min and temperature of 100˜200° C.;

3) extruding sheets on open mixer or double cone/double wrist sheeting extruder;

4) cooling;

5) re-adding vulcanizing agent to the internal mixer or open mixer and produce sheets;

6) obtaining the finished product after cooling.

### Embodiment 2

A natural rubber with high strength, high elongation and high resilience, comprising the following raw materials in mass part: 100 phr of RSS3, 0 phr of 3 L rubber, 100 phr of CV60 constant viscosity rubber, 2 phr of zinc oxide, 3 phr of stearic acid, 0.2 phr of polyethylene glycol, 20 phr of nano calcium carbonate, 2 phr of nano kaolin, 20 phr of naphthenic oil, 0.1 phr of sulfur, 3 phr of rubber accelerator.

Preferably, a natural rubber with high strength, high elongation and high resilience, it is made by the following steps:

1) adding RSS3, 3 L rubber, CV60 constant viscosity rubber, zinc oxide, stearic acid, polyethylene glycol, nano calcium carbonate, nano kaolin, naphthenic oil, sulfur, rubber accelerator into the rubber internal mixer in order;

2) mixing at a speed of 5˜50 r/min and a cooling water flux of 1˜50 m³/h, and discharging after reaching the time of 30˜120 min and temperature of 100˜200° C.;

3) extruding sheets on open mixer or double cone/double wrist sheeting extruder;

4) cooling;

5) re-adding vulcanizing agent to the internal mixer or open mixer and produce sheets;

6) obtaining the finished product after cooling.

### Embodiment 3

A natural rubber with high strength, high elongation and high resilience, comprising the following raw materials in mass part: 50 phr of RSS3, 50 phr of 3 L rubber, 50 phr of CV60 constant viscosity rubber, 11 phr of zinc oxide, 1.6 phr of stearic acid, 1.1 phr of polyethylene glycol, 11 phr of nano calcium carbonate, 8 phr of nano kaolin, 11 phr of naphthenic oil, 1 phr of sulfur, 1.7 phr of rubber accelerator.

Preferably, a natural rubber with high strength, high elongation and high resilience, it is made by the following steps:

1) adding RSS3, 3 L rubber, CV60 constant viscosity rubber, zinc oxide, stearic acid, polyethylene glycol, nano calcium carbonate, nano kaolin, naphthenic oil, sulfur, rubber accelerator into the rubber internal mixer in order;

2) mixing at a speed of 5˜50 r/min and a cooling water flux of 1˜50 m³/h, and discharging after reaching the time of 30˜120 min and temperature of 100˜200° C.;

3) extruding sheets on open mixer or double cone/double wrist sheeting extruder;

4) cooling;

5) re-adding vulcanizing agent to the internal mixer or open mixer and produce sheets;

6) obtaining the finished product after cooling.

The above description is only the preferred embodiments of the invention, but the protection scope of the invention is not limited to this, those skilled in this art makes equivalent replacement or change according to the technical scheme and inventive concept of the invention within the technical scope disclosed by the invention, which shall be covered by the protection scope of the invention.

1. A natural rubber with high strength, high elongation and high resilience, wherein it comprises the following raw materials in mass part: 0˜100 phr of RSS3, 0˜100 phr of 3 L rubber, 0˜100 phr of CV60 constant viscosity rubber, 2˜20 phr of zinc oxide, 0.1˜3 phr of stearic acid, 0.2˜2 phr of polyethylene glycol, 1˜20 phr of nano calcium carbonate, 2˜15 phr of nano kaolin, 2˜20 phr of naphthenic oil, 0.1˜2 phr of sulfur, 0.5˜3 phr of rubber accelerator.

2. A natural rubber with high strength, high elongation and high resilience according to claim 1, wherein it is made by the following steps:
1) adding RSS3, 3 L rubber, CV60 constant viscosity rubber, zinc oxide, stearic acid, polyethylene glycol, nano calcium carbonate, nano kaolin, naphthenic oil, sulfur, rubber accelerator into the rubber internal mixer in order;
2) mixing at a speed of 5˜50 r/min and a cooling water flux of 1˜50 m³/h, and discharging after reaching the time of 30˜120 min and temperature of 100˜200° C.;
3) extruding sheets on open mixer or double cone/double wrist sheeting extruder;
4) cooling;
5) re-adding vulcanizing agent to the internal mixer or open mixer and produce sheets;
6) obtaining the finished product after cooling.
